(19) United States
(12) Patent Application Publication
(10) Pub. No.: US 2015/0155649 A1
(43) Pub. Date: Jun. 4, 2015

(54) MOUNTING STRUCTURE FOR CYLINDRICAL PACKING

(71) Applicant: YAZAKI CORPORATION, Tokyo (JP)

(72) Inventors: Takashi MURO, Shizuoka (JP); Masayuki SAITOH, Shizuoka (JP)

(21) Appl. No.: 14/620,243

(22) Filed: Feb. 12, 2015

Related U.S. Application Data
(63) Continuation of application No. PCT/JP2013/078360, filed on Oct. 18, 2013.

(30) Foreign Application Priority Data
Oct. 29, 2012 (JP) 2012-237637

(51) Int. Cl. H01R 13/52

(52) U.S. Cl. CPC H01R 13/5202

(57) ABSTRACT

In a mounting structure for cylindrical packing for mounting a cylindrical packing on a fitting cylindrical portion of a housing, an outer circumferential surface of the fitting cylindrical portion includes: an intermediate outer surface, end outer surfaces formed into a narrower external shape than the intermediate outer surface, and a protruding strip extending axially on the end outer surface and formed such that a most protruding position from the end outer surface falls within a range of the external shape of the intermediate outer surface, and an inner circumferential surface of the cylindrical packing includes: an intermediate inner surface which is tightly attached and fitted to the intermediate outer surface, and end inner surfaces fitted to the end outer surfaces. An engagement groove extends on the end inner surfaces.

### CROSS REFERENCE TO RELATED APPLICATION(S)

This application is a continuation of PCT application No. PCT/JP2013/078360, which was filed on Oct. 18, 2013 based on Japanese Patent Application (No. 2012-237637) filed on Oct. 29, 2012, the contents of which are incorporated herein by reference.

### BACKGROUND OF THE INVENTION

1. Field of the Invention

The present invention relates to a mounting structure for cylindrical packing for use in a waterproof connector etc.

2. Description of the Related Art

FIG. 7 to FIG. 10 show a waterproof connector disclosed in JP-A-H07-142116.

In this waterproof connector 100, as shown in FIG. 9, a gap between a cylindrical portion 110 of a second housing and a fitting cylindrical portion 121 of a first housing 120 which is inserted into an inner circumference of the cylindrical portion 110 is sealed watertightly by a cylindrical packing 130 which is fitted (placed and fitted) on an outer circumferential surface of the fitting cylindrical portion 121.

As shown in FIG. 7, the fitting cylindrical portion 121 of the first housing 120 has terminal receiving holes 122 in each of which a connection terminal (not shown) is received internally. As shown in FIG. 8B and FIG. 9, protruding strips 123 provided for preventing the cylindrical packing 130 from being displaced circumferentially extend axially on the outer circumferential surface of the fitting cylindrical portion 121. The protruding strips 123 are provided in a plurality of places (six places in FIG. 8) of the outer circumferential surface of the fitting cylindrical portion 121. As shown in FIG. 9, the protruding strips 123 extend from positions which are located rearward by a length L1 from a front end 121a of the fitting cylindrical portion 121 toward a rear end of the fitting cylindrical portion 121.

The fitting cylindrical portion 121 has a smooth outer surface in the range of the length L1 where the protruding strips 123 on the front end 121a side are not provided. The smooth outer surface serves as a seal surface 127 (see FIG. 9) which is tightly attached to an inner circumferential surface of the cylindrical packing 130 to exert sealing performance.

As shown in FIG. 7 and FIG. 9, the first housing 120 has packing lock holes 125 in opposite outer side walls 124 of the rear end side of the fitting cylindrical portion 121. The packing lock holes 125 are engaged with respective engagement protrusions 131 provided to protrude from outer side portions of a front end of the cylindrical packing 130. Thus, the cylindrical packing 130 can be prevented from coming off.

As shown in FIG. 7, the cylindrical packing 130 includes the engagement protrusions 131 and lip portions 132 in its outer circumferential surface. The engagement protrusions 131 are provided to protrude from the opposite sides of the front end 130a of the outer circumferential surface of the cylindrical packing 130. When the engagement protrusions 131 are engaged with the above-described packing lock holes 125, the cylindrical packing 130 can be prevented from coming off. The lip portions 132 are formed to protrude annularly on the outer circumferential surface of the cylindrical packing 130. The two lip portions 132 are provided and tightly attached to the inner circumferential surface of the cylindrical portion 110 of the second housing to thereby seal a gap between the cylindrical packing 130 and the cylindrical portion 110 watertightly.

As shown in FIG. 8A, an inner circumferential surface 135 of the cylindrical packing 130 has the same shape as the seal surface 127. In addition, the inner circumferential surface of the cylindrical packing 130 is set to have an inner diameter which is slightly smaller than the external shape of the seal surface 127 so that the inner circumferential surface of the cylindrical packing 130 can be tightly attached and fitted to the seal surface 127. As shown in FIG. 8A and FIG. 9, engagement grooves 133 are formed in the inner circumferential surface of the cylindrical packing 130 so that the engagement grooves 133 can be fitted to the protruding strips 123 of the fitting cylindrical portion 121.

As shown in FIG. 9, the engagement grooves 133 are formed in the cylindrical packing 130 except the range of the length L1 from a rear end of the cylindrical packing 130. As shown in FIG. 10, when the fitting of the cylindrical packing 130 to the fitting cylindrical portion 121 is completed, the inner circumferential surface 135 in the range of the length L1 from the rear end of the cylindrical packing 130 is superimposed on the seal surface 127 of the fitting cylindrical portion 121 to thereby seal the gap between the cylindrical packing 130 and the fitting cylindrical portion 121 watertightly.

### SUMMARY OF THE INVENTION

However, in the a mounting structure for the cylindrical packing 130 in the waterproof connector according to JP-A-H07-142116, the protruding strips 123 on the fitting cylindrical portion 121 are formed in the positions located rearward by the length L1 from the front end 121a of the fitting cylindrical portion 121. Thus, in a fitting initial stage for fitting the cylindrical packing 130 onto the fitting cylindrical portion 121, the protruding strips 123 and the engagement grooves 133 are not yet in a fitting state. As a result, for example, when fitting is to start in the state in which the axis of the cylindrical packing 130 is inclined with respect to the axis of the fitting cylindrical portion 121 in the fitting initial stage, circumferential distortion or displacement occurs in the cylindrical packing 130. There is therefore a fear that it may be difficult to perform the fitting work.

In addition, the protruding strips 123 are formed to protrude outward from the seal surface 127. Therefore, sink marks produced at the time of molding the protruding strips 123 fall on the seal surface 127. Thus, there is a fear that sealing performance may be deteriorated.

The present invention has been accomplished in consideration of the above-described circumstances. An object of the invention is to provide a mounting structure for a cylindrical packing in which a work for fitting a cylindrical packing on a fitting cylindrical portion can be made easy and sealing performance achieved by the cylindrical packing can be improved.

The above-described object of the present invention can be accomplished by the following configurations.

(1) A mounting structure for cylindrical packing for mounting a cylindrical packing on a fitting cylindrical portion of a first housing to be inserted into an inner circumference of a cylindrical portion of a second housing such that the cylindrical packing is fitted onto an outer circumferential surface of the fitting cylindrical portion to thereby seal a gap between the cylindrical portion and the fitting cylindrical portion watertightly,

wherein the outer circumferential surface of the fitting cylindrical portion includes an intermediate portion outer circumferential surface which has a fixed external shape, end portion outer circumferential surfaces which are formed in opposite front and rear ends of the intermediate portion outer circumferential surface, respectively, and each of which is formed into a narrower external shape by removing a fixed thickness from the external shape of the intermediate portion outer circumferential surface, and a protruding strip which extends axially on the end portion outer circumferential surface provided on a front end side of the fitting cylindrical portion and which is formed by the thickness removal for forming the end portion outer circumferential surfaces such that a most protruding position of the protruding strip from the end portion outer circumferential surface falls within a range of the external shape of the intermediate portion outer circumferential surface,

wherein an inner circumferential surface of the cylindrical packing includes an intermediate portion inner circumferential surface which is tightly attached and fitted to the intermediate portion outer circumferential surface, and end portion inner circumferential surfaces which are formed in opposite front and rear ends of the intermediate portion inner circumferential surface to have a smaller diameter than the intermediate portion inner circumferential surface to be thereby fitted to the end portion outer circumferential surfaces, respectively,

wherein an engagement groove which allows the protruding strip to be fitted therein is provided on the end portion inner circumferential surfaces on the opposite ends so as to extend along front and rear directions, and

wherein a gap between the fitting cylindrical portion and the cylindrical packing is sealed watertightly due to tight attachment between the intermediate portion outer circumferential surface and the intermediate portion inner circumferential surface.

(2) The mounting structure for cylindrical packing according to the above-described (1),

wherein a position of a front end of the protruding strip is aligned with a position of a front end of the fitting cylindrical portion.

(3) The mounting structure for cylindrical packing according to the above-described (1) or (2),

wherein the external shape of each of the intermediate portion outer circumferential surface and the end portion outer circumferential surfaces is a shape of a rounded rectangle, and

wherein the protruding strip is provided to protrude from a corner portion of the rectangle.

According to the above-described configuration (1), the protruding strip provided on the outer circumferential surface of the fitting cylindrical portion in order to prevent the cylindrical packing from being displaced circumferentially is disposed on the front end side of the outer circumferential surface of the fitting cylindrical portion. Therefore, in a fitting initial stage for fitting the cylindrical packing to the fitting cylindrical portion, the protruding strip is fitted to the engagement groove of the cylindrical packing to prevent the cylindrical packing from being displaced circumferentially. Accordingly, distortion or displacement can be prevented from occurring in the cylindrical packing even when the cylindrical packing is fitted obliquely in the fitting initial stage. As a result, the work for fitting the cylindrical packing on the fitting cylindrical portion can be made easy.

In addition, according to the above-described configuration (1), the intermediate portion outer circumferential surface which is the largest in outer diameter of the outer circumferential surface of the fitting cylindrical portion serves as a seal surface which is tightly attached to the cylindrical packing to exert sealing performance. In addition, the protruding strip provided on the outer circumferential surface of the fitting cylindrical portion in order to prevent the cylindrical packing from being displaced circumferentially is formed in the end portion outer circumferential surfaces formed to be narrower than the intermediate portion outer circumferential surface serving as the seal surface. Moreover, the protruding strip is formed by thickness removal such that the protruding strip falls within the range of the external shape of the intermediate portion outer circumferential surface. Therefore, sink marks produced at the time of molding the protruding strips can be prevented from falling onto the intermediate portion outer circumferential surface so that sealing performance can be prevented from being deteriorated by the sink marks.

Further, steps formed in boundaries between the end portion inner circumferential surfaces and the intermediate portion inner circumferential surface of the cylindrical packing abut against steps in the opposite ends of the intermediate portion outer circumferential surface of the fitting cylindrical portion, so that the cylindrical packing can be restrained from moving axially. The steps formed in the boundaries between the end portion inner circumferential surfaces and the intermediate portion inner circumferential surface of the cylindrical packing are shaped like rings extending over the whole circumference of the opposite ends of the intermediate portion inner circumferential surface so that the steps of the cylindrical packing can abut against the steps of the fitting cylindrical portion respectively all over the circumference in the circumferential direction. Thus, the range of the abutment is large. Therefore, even when the axial length of each of the opposite end portions of the cylindrical packing is reduced, stable positioning strength can be secured. In other words, the axial length of each of the opposite end portions of the cylindrical packing having the end portion inner circumferential surfaces can be reduced without deteriorating mounting strength of the cylindrical packing on the fitting cylindrical portion. Thus, the axial length of the intermediate portion inner circumferential surface of the cylindrical packing and the axial length of the intermediate portion outer circumferential surface of the fitting cylindrical portion can be increased correspondingly. Accordingly, sealing performance achieved by the cylindrical packing can be improved.

That is, according to the above-described configuration (1), sealing performance can be prevented from being deteriorated by sink marks. In addition, the axial length of the intermediate portion inner circumferential surface of the cylindrical packing and the axial length of the intermediate portion outer circumferential surface of the fitting cylindrical portion, which surfaces serve as seal surfaces, can be increased. Thus, sealing performance achieved by the cylindrical packing can be improved.

In addition, according to the above-described configuration (1), the front end portion and the rear end portion of the cylindrical packing can be made to have the same structure so that front/rear directionality can be eliminated from the cylindrical packing. Therefore, when the cylindrical packing is mounted on the fitting cylindrical portion, it is not necessary to identify the front/rear direction of the cylindrical packing but it is possible to improve mounting handleability.

According to the above-described configuration (2), the position of the front end of the protruding strip is aligned with the position of the front end of the fitting cylindrical portion. Accordingly, when the cylindrical packing starts to be fitted to the fitting cylindrical portion, the protruding strip on the fitting cylindrical portion starts to be fitted to the engagement groove of the cylindrical packing so immediately that the cylindrical packing can be prevented from being displaced circumferentially. Therefore, even when the cylindrical packing is fitted obliquely at the beginning of the fitting, distortion or displacement can be prevented from occurring in the cylindrical packing so that the work for fitting the cylindrical packing on the fitting cylindrical portion can be further made easy.

According to the above-described configuration (3), when the cylindrical packing starts to be fitted to the fitting cylindrical portion, positioning between the protruding strip and the engagement groove becomes easy so that the mounting workability of the cylindrical packing can be further improved.

The invention has been described above briefly. Further, when a mode for carrying out the invention (hereinafter referred to as “embodiment”) which will be described below is read through with reference to the accompanying drawings, the details of the invention can be made further clear.

### BRIEF DESCRIPTION OF THE DRAWINGS

FIG. 1 is a perspective view of an assembly made up of a first housing and a cylindrical packing in an embodiment of a waterproof connector which uses a mounting structure for cylindrical packing according to the invention.

FIG. 2 is a front view of the assembly shown in FIG. 1.

FIG. 3 is a sectional view taken along the line A-A in FIG. 2.

FIG. 4 is a perspective view of the first housing standing alone in the embodiment.

FIG. 5 is a perspective view in which a part of an external wall of the first housing in the embodiment is broken to expose a side surface of a fitting cylindrical portion.

FIG. 6 is a perspective view of the cylindrical packing standing alone in the embodiment.

FIG. 7 is a perspective view of a cylindrical packing and a first housing in a waterproof connector according to the background art.

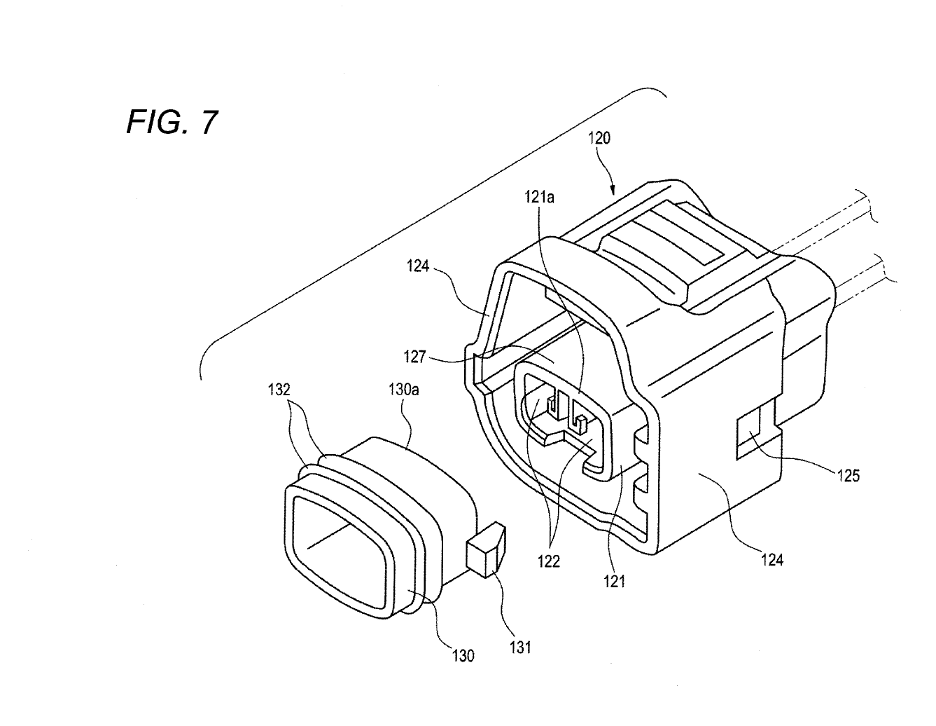

FIG. 8A is a front view of the cylindrical packing shown in FIG. 7, and FIG. 8B is a front view of the first housing shown in FIG. 7.

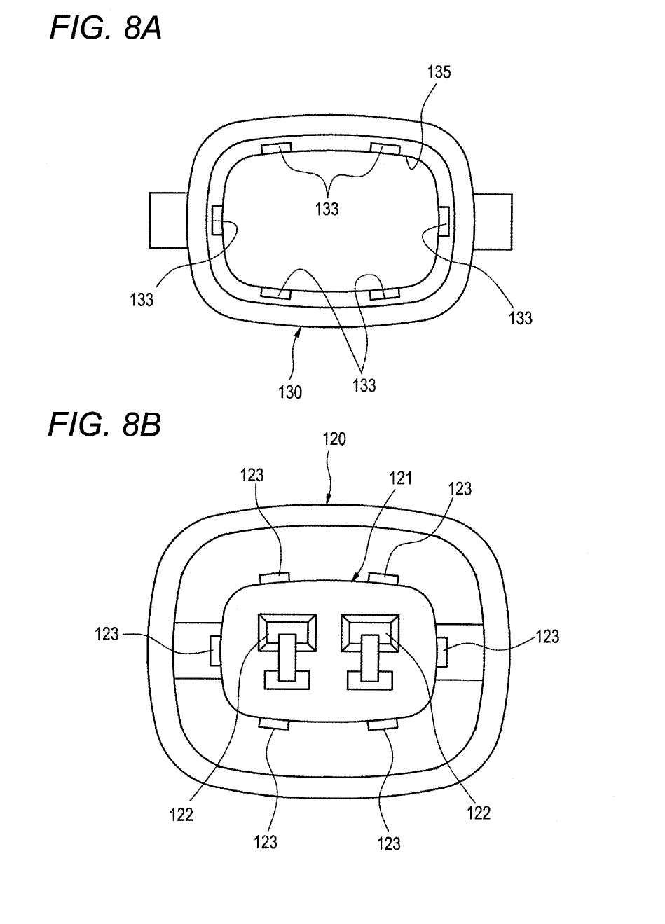

FIG. 9 is a vertical sectional view of the first housing, a second housing and the cylindrical packing constituting the waterproof connector shown in FIG. 7.

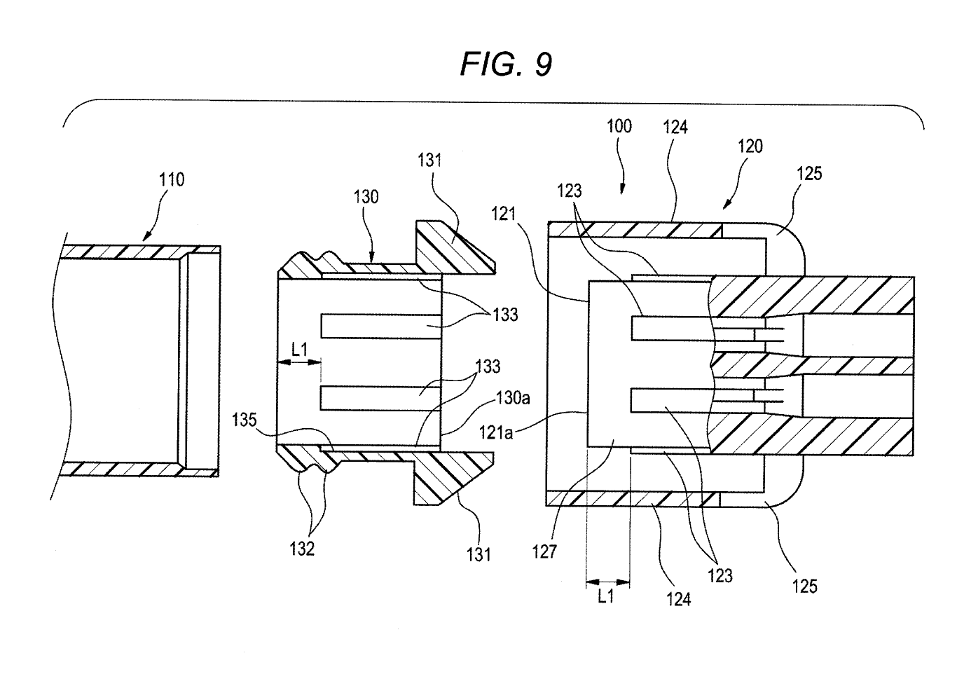

FIG. 10 is a vertical sectional view of a state in which the cylindrical packing is mounted on the first housing shown in FIG. 9.

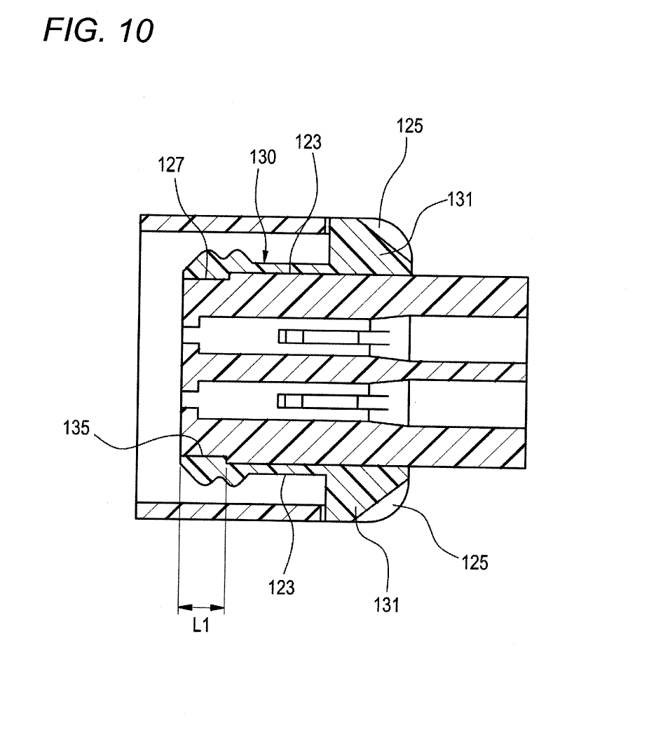

### DETAILED DESCRIPTION OF THE EXEMPLARY EMBODIMENTS

A preferred embodiment of a mounting structure for cylindrical packing according to the invention will be described below in detail with reference to the drawings.

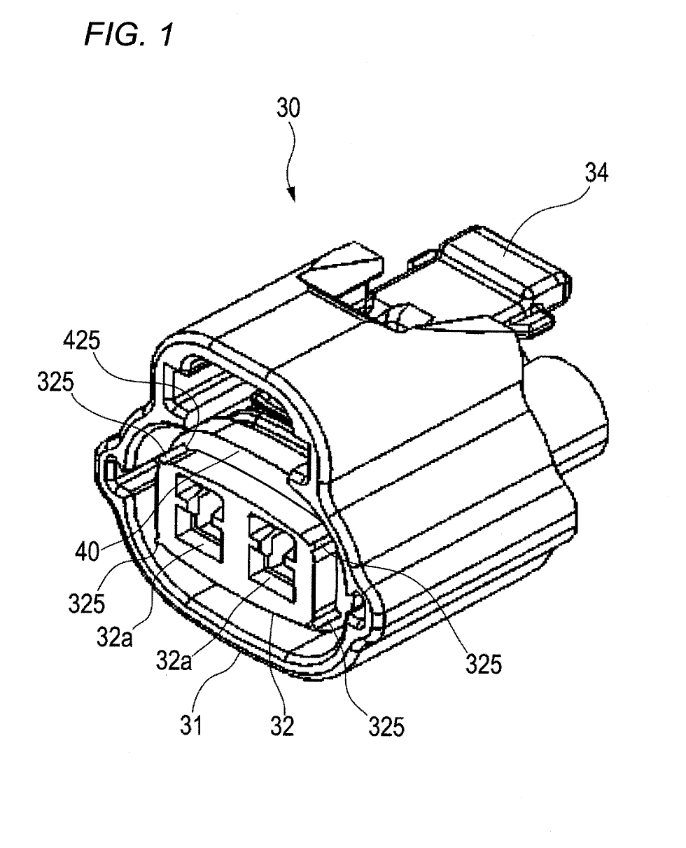

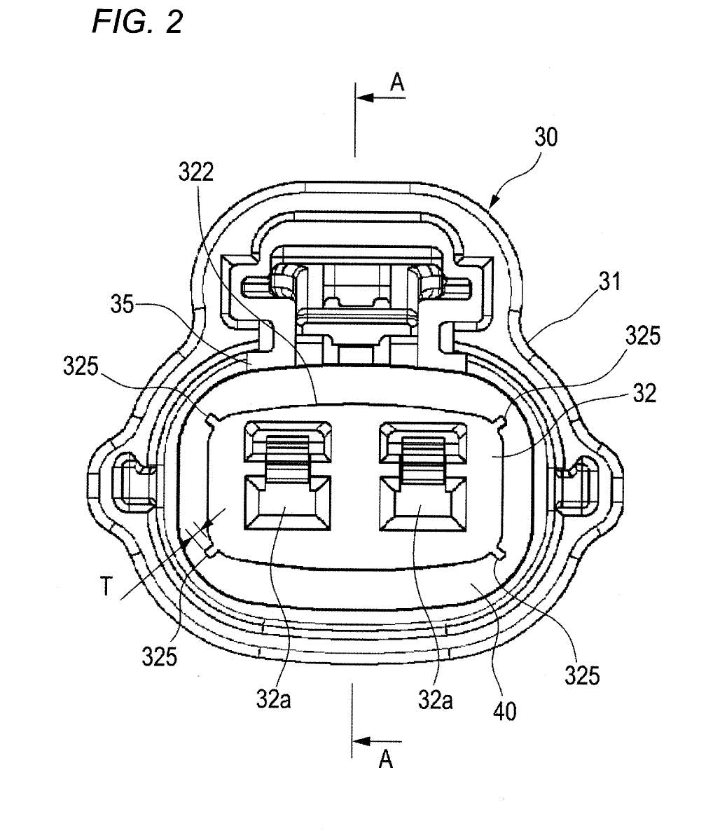

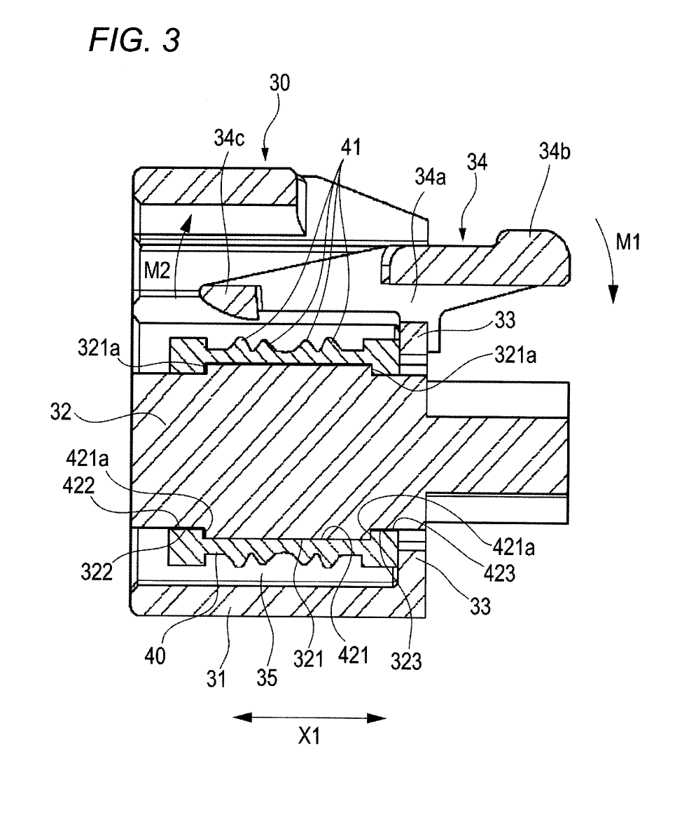

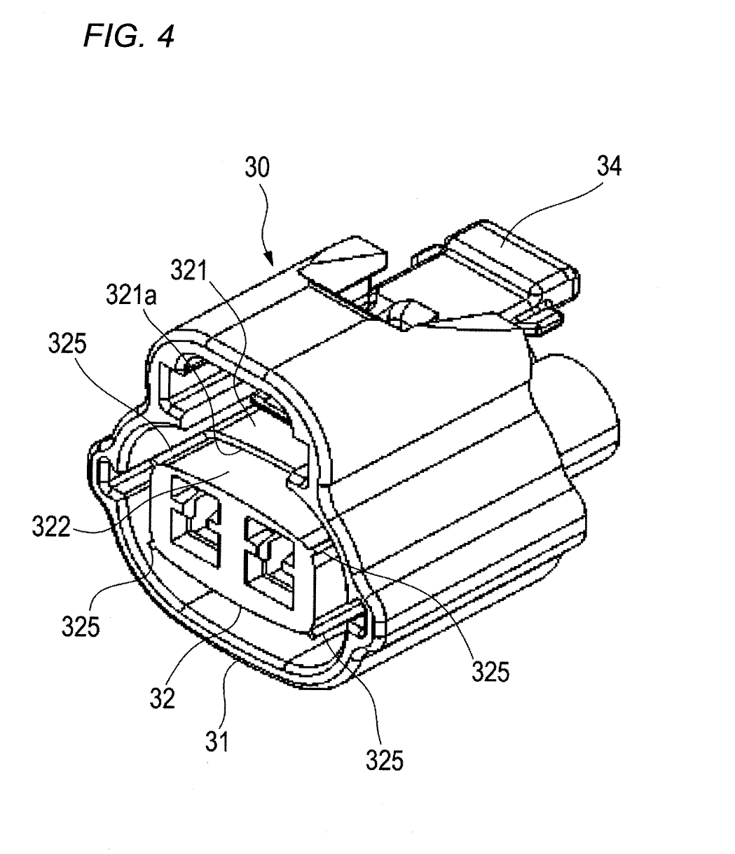

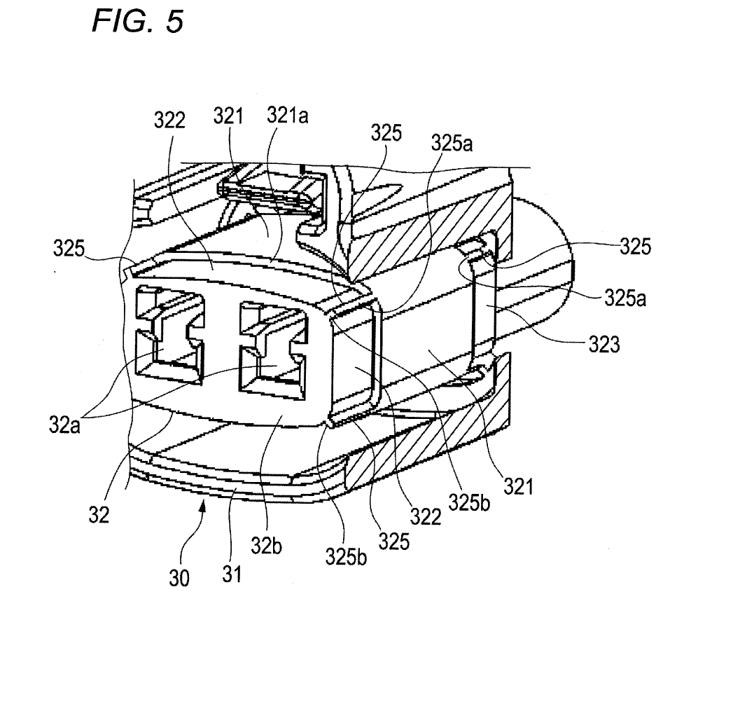

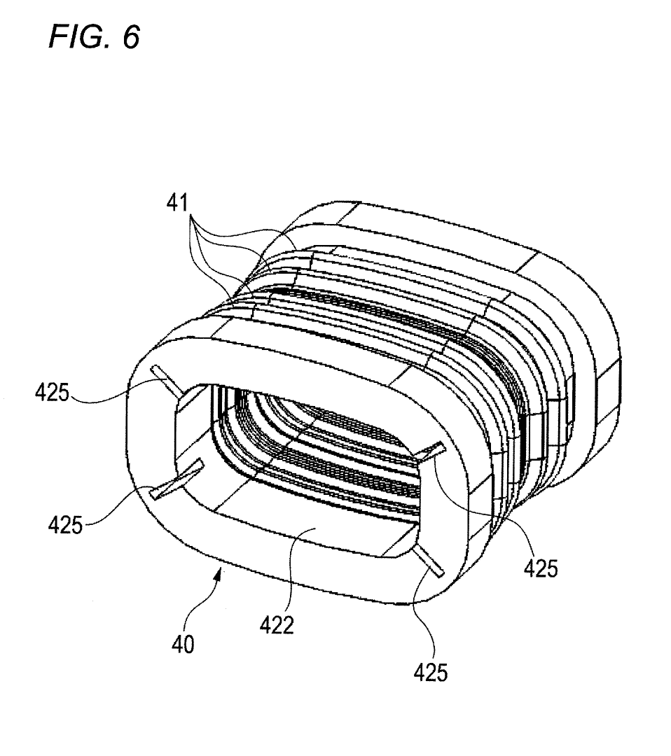

FIG. 1 to FIG. 6 are views showing a first housing and a cylindrical packing in an embodiment of a waterproof connector which uses the mounting structure for cylindrical packing according to the invention. FIG. 1 is a perspective view of an assembly made up of the first housing and the cylindrical packing in the waterproof connector in the embodiment. FIG. 2 is a front view of the assembly shown in FIG. 1. FIG. 3 is a sectional view taken along the line A-A in FIG. 2. FIG. 4 is a perspective view of the first housing standing alone in the embodiment. FIG. 5 is a perspective view in which a part of an external wall of the first housing in the embodiment is broken to expose a side surface of a fitting cylindrical portion. FIG. 6 is a perspective view of the cylindrical packing standing alone in the embodiment.

As shown in FIG. 1 to FIG. 3, the first housing 30 is an item which is formed out of a resin by injection molding. The first housing 30 has an outer cylindrical wall portion 31, a fitting cylindrical portion 32 which is disposed inside the outer cylindrical wall portion 31, and a lock arm 34 which is provided in a housing rear end portion 33 in order to connect the outer cylindrical wall portion 31 and the fitting cylindrical portion 32 to each other. A cylindrical packing 40 is fitted on an outer circumference of the fitting cylindrical portion 32.

The outer cylindrical wall portion 31 and the fitting cylindrical portion 32 define a housing fitting space 35. The housing fitting space 35 is a space into which a cylindrical portion of a second housing (not shown) as a fitting mate of the first housing 30 is fitted.

As shown in FIG. 1 and FIG. 2, terminal receiving holes 32a are formed internally in the fitting cylindrical portion 32 to penetrate the fitting cylindrical portion 32. Each of the terminal receiving holes 32a receives and retains a terminal fitting (not shown) which is fitted and connected to a connection terminal (not shown) retained in the second housing.

The fitting cylindrical portion 32 is a portion inserted into an inner circumference of the cylindrical portion of the second housing. A cylindrical packing 40 is fitted on an outer circumferential surface of the fitting cylindrical portion 32. The cylindrical packing 40 fitted on the outer circumferential surface of the fitting cylindrical portion 32 seals a gap between the cylindrical portion (not shown) fitted into the housing fitting space 35 and the fitting cylindrical portion 32.

In the case of the embodiment, as shown in FIG. 3 and FIG. 5, the outer circumferential surface of the fitting cylindrical portion 32 includes an intermediate portion outer circumferential surface 321, end portion outer circumferential surfaces 322 and 323 which are formed to extend to opposite front and rear ends of the intermediate portion outer circumferential surface 321 respectively, and protruding strips 325 which are provided to protrude from an outer circumference of each of the end portion outer circumferential surfaces 322 and 323.

The intermediate portion outer circumferential surface 321 is an outer circumferential surface in a range corresponding to an intermediate portion of the fitting cylindrical portion 32 in a front/rear direction (the front/rear direction means a direction of an arrow X1 in FIG. 3, which is also an axial direction of the fitting cylindrical portion 32). The external shape of the intermediate portion outer circumferential surface 321 in horizontal section is a rounded rectangle. The external shape of the intermediate portion outer circumferential surface 321 in horizontal section is fixed all over the length in the axial direction.

The end portion outer circumferential surface 322 is an outer circumferential surface of a front end 32b side of the fitting cylindrical portion 32. The end portion outer circumferential surface 323 is an outer circumferential surface of a rear end side of the fitting cylindrical portion 32.

The end portion outer circumferential surface 322 and the end portion outer circumferential surface 323 have the same external shape formed as a narrower external shape which is obtained by removing a predetermined thickness from the external shape of the intermediate portion outer circumferential surface 321, as shown in FIG. 4. The external shape of each of the end portion outer circumferential surface 322 and the end portion outer circumferential surface 323 in horizontal section is the shape of a rounded rectangle which is concentric and similar to that of the intermediate portion outer circumferential surface 321. Each of the end portion outer circumferential surface 322 and the end portion outer circumferential surface 323 is formed to be narrower than the intermediate portion outer circumferential surface 321. As a result, two steps 321a are formed in opposite ends of the intermediate portion outer circumferential surface 321 respectively, as shown in FIG. 3.

The protruding strips 325 extend axially on each of the end portion outer circumferential surfaces 322 and 323. In the case of the embodiment, the protruding strips 325 are provided to protrude from four sectional corner portions of the rectangular section of each of the end portion outer circumferential surfaces 322 and 323, as shown in FIG. 2. Further, the protruding strips 325 are formed by the thickness removal for forming the end portion outer circumferential surfaces 322 and 323 so that the most protruding positions of the protruding strips 325 from each of the end portion outer circumferential surfaces 322 and 323 can fall within the range of the external shape of the intermediate portion outer circumferential surface 321. That is, the protruding length T (see FIG. 2) of each of the protruding strips 325 from each of the end portion outer circumferential surfaces 322 and 323 is set to be not larger than the thickness which is removed from the external shape of the intermediate portion outer circumferential surface 321. In the case of the embodiment, the protruding length T of the protruding strip 325 is set to be as large as the removed thickness. Accordingly, a most protruding surface 325a (i.e. an end surface) of the protruding strip 325 is connected to and flush with the intermediate portion outer circumferential surface 321, as shown in FIG. 5.

In the case of the embodiment, the position of a front end 325b of the protruding strip 325 is aligned with the position of the front end 32b of the fitting cylindrical portion 32, as shown in FIG. 5.

The lock arm 34 in the first housing 30 includes a swinging fulcrum portion 34a which is located in an intermediate portion of the lock arm 34 in a longitudinal direction (i.e. in the direction of the arrow X1 in FIG. 3) and which is connected to the housing rear end portion 33, a pushing-down operation portion 34b which is located at the rear end of the lock arm 34 in the longitudinal direction, and an engagement portion 34c which is located at the front end of the lock arm 34 in the longitudinal direction.

When the front end engagement portion 34c is engaged with a lock protrusion provided to protrude from the outer circumferential surface of the cylindrical portion of the second housing, the lock arm 34 locks a connection state between the housings.

When the pushing-down operation portion 34b is pushed down in a direction of an arrow M1 in FIG. 3, the lock arm 34 rotates in a clockwise direction in FIG. 3 with the swinging fulcrum portion 34a as the fulcrum so that the engagement portion 34c can escape in a direction of an arrow M2 in FIG. 3. Thus, the engagement between the lock arm 34 and the cylindrical portion of the second housing can be released.

The cylindrical packing 40 is formed out of a waterproof elastic material such as synthetic rubber. As shown in FIG. 3 and FIG. 6, a plurality of lip portions 41 are provided in the outer circumferential surface of the cylindrical packing 40 in intervals in the axial direction (i.e. the direction of the arrow X1 in FIG. 3). Each of the lip portions 41 is an annular protruding strip which is laid around the outer circumferential surface of the cylindrical packing 40. The lip portions 41 are tightly attached to the inner circumferential surface of the cylindrical portion of the second housing to thereby seal a gap between the cylindrical packing 40 and the cylindrical portion.

As shown in FIG. 3, the inner circumferential surface of the cylindrical packing 40 includes an intermediate portion inner circumferential surface 421, end portion inner circumferential surfaces 422 and 423 which are formed to extend toward opposite front and rear ends of the intermediate portion inner circumferential surface 421 respectively, and engagement grooves 425 which are formed in each of the end portion inner circumferential surfaces 422 and 423.

The intermediate portion inner circumferential surface 421 is an inner circumferential surface of a range corresponding to an intermediate portion of the cylindrical packing 40 in the front/rear direction (the front/rear direction means the direction of the arrow X1 in FIG. 3, which is also the axial direction of the cylindrical packing 40). The internal shape of the intermediate portion inner circumferential surface 421 in horizontal section is the shape of a rounded rectangle similar to that of the intermediate portion outer circumferential surface 321 of the fitting cylindrical portion 32. The internal size of the intermediate portion inner circumferential surface 421 in horizontal section is set to be slightly smaller than the external size of the intermediate portion outer circumferential surface 321 so that the intermediate portion inner circumferential surface 421 can be tightly attached and fitted to the intermediate portion outer circumferential surface 321. The internal shape of the intermediate portion inner circumferential surface 421 in horizontal section is fixed all over the axial length.

Each of the end portion inner circumferential surfaces 422 and 423 is formed to be concentric to the intermediate portion inner circumferential surface 421 and have a smaller diameter than that of the intermediate portion inner circumferential surface 421. The end portion inner circumferential surfaces 422 and 423 are tightly attached and fitted to the end portion outer circumferential surfaces 322 and 323 in the fitting cylindrical portion 32 respectively. In the case of the embodiment, the end portion inner circumferential surface 422 and the end portion inner circumferential surface 423 are formed to have the same dimensions.

Each of the end portion inner circumferential surface 422 and the end portion inner circumferential surface 423 is formed to have a smaller diameter than that of the intermediate portion inner circumferential surface 421. As a result, steps 421a are formed in the opposite ends of the intermediate portion inner circumferential surface 421, as shown in FIG. 3. In the cylindrical packing 40 fitted on the fitting cylindrical portion 32, as shown in FIG. 3, the steps 421a of the packing side abut against the steps 321a of the fitting cylindrical portions 32 side. In this manner, the cylindrical packing 40 can be restrained from moving axially.

The engagement grooves 425 extend axially on the end portion inner circumferential surfaces 422 and 423 in the opposite ends so that the protruding strips 325 of the fitting cylindrical portion 32 can be fitted into the engagement grooves 425. The engagement grooves 425 are provided in the four corners of the end portion inner circumferential surfaces 422 and 423 correspondingly to the arrangement of the protruding strips 325 in the fitting cylindrical portion 32. In addition, in the case of the embodiment, the engagement grooves 425 are set to have a groove width so that the protruding strips 325 can be tightly attached and fitted into the engagement grooves 425. In the embodiment, fitting between the engagement grooves 425 and the protruding strips 325 may not only prevent the cylindrical packing 40 from being displaced circumferentially but also generate a friction force to restrain the cylindrical packing 40 and the fitting cylindrical portion 32 from axially moving relative to each other so as to enhance the performance with which the cylindrical packing 40 can prevent the fitting cylindrical portion 32 from coming off.

In the above-described mounting structure for cylindrical packing, when the fitting of the cylindrical packing 40 on the fitting cylindrical portion 32 is completed as shown in FIG. 3, a gap between the fitting cylindrical portion 32 and the cylindrical packing is sealed by the tight attachment between the intermediate portion outer circumferential surface 321 and the intermediate portion inner circumferential surface 421.

In the mounting structure for cylindrical packing according to the embodiment which has been described above, the protruding strips 325 provided on the outer circumferential surface of the fitting cylindrical portion 32 in order to prevent the cylindrical packing 40 from being displaced circumferentially are disposed on the front end side of the outer circumferential surface of the fitting cylindrical portion 32. Therefore, in the fitting initial stage for fitting the cylindrical packing 40 to the fitting cylindrical portion 32, the protruding strips 325 are fitted to the engagement grooves 425 of the cylindrical packing 40 respectively. Thus, the cylindrical packing 40 can be prevented from being displaced circumferentially.

Therefore, distortion or displacement can be prevented from occurring in the cylindrical packing 40 even when the cylindrical packing 40 is fitted obliquely in the fitting initial stage. As a result, the work for fitting the cylindrical packing 40 on the fitting cylindrical portion 32 can be made easy.

In addition, in the mounting structure for cylindrical packing according to the embodiment, the intermediate portion outer circumferential surface 321 which is the largest in outer diameter of the outer circumferential surface of the fitting cylindrical portion 32 serves as a seal surface which is tightly attached to the cylindrical packing 40 to exert sealing performance. In addition, the protruding strips 325 provided on the outer circumferential surface of the fitting cylindrical portion 32 in order to prevent the cylindrical packing 40 from being displaced circumferentially are formed in the end portion outer circumferential surfaces 322 and 323 each of which is formed to be narrower than the intermediate portion outer circumferential surface 321 serving as the seal surface. In addition, the protruding strips 325 are formed by thickness removal so that the protruding strips 325 can fall within the range of the external shape of the intermediate portion outer circumferential surface 321. Therefore, sink marks produced at the time of molding the protruding strips 325 can be prevented from falling on the intermediate portion outer circumferential surface 321 so that sealing performance can be prevented from being deteriorated by the sink marks.

Further, when the steps 421a formed in the boundaries between the end portion inner circumferential surfaces 422 and 423 and the intermediate portion inner circumferential surface 421 abut against the steps 321a in the opposite ends of the intermediate portion outer circumferential surface 321 of the fitting cylindrical portion 32, the cylindrical packing 40 can be restrained from moving axially. The steps 421a formed in the boundaries between the end portion inner circumferential surfaces 422 and 423 and the intermediate portion inner circumferential surface 421 of the cylindrical packing 40 are shaped like rings extending over the whole circumferences of the opposite ends of the intermediate portion inner circumferential surface 421 so that the steps 421a can abut against the steps 321a all over the circumference in the circumferential direction. Thus, the range of the abutment is large. Therefore, stable positioning strength can be secured even when the axial length of each of the opposite end portions of the cylindrical packing 40 is reduced. In other words, the axial length of each of the opposite end portions of the cylindrical packing 40 having the end portion inner circumferential surfaces 422 and 423 can be reduced without deteriorating the mounting strength of the cylindrical packing 40 on the fitting cylindrical portion 32 so that the axial length of the intermediate portion inner circumferential surface 421 of the cylindrical packing 40 and the axial length of the intermediate portion outer circumferential surface 321 of the fitting cylindrical portion 32 can be increased correspondingly.

That is, in the mounting structure for cylindrical packing according to the embodiment, sealing performance can be prevented from being deteriorated by sink marks. In addition, the axial length of the intermediate portion inner circumferential surface 421 of the cylindrical packing 40 and the axial length of the intermediate portion outer circumferential surface 321 of the fitting cylindrical portion 32, which surfaces serve as seal surfaces, can be increased so that the sealing performance achieved by the cylindrical packing 40 can be improved.

In addition, in the mounting structure for cylindrical packing according to the embodiment, the front end portion and the rear end portion of the cylindrical packing 40 are made to have the same structure so that front/rear directionality can be eliminated from the cylindrical packing 40. Therefore, when the cylindrical packing 40 is mounted on the fitting cylindrical portion 32, it is not necessary to identify the front/rear direction of the cylindrical packing 40 but it is possible to improve mounting handleability.

Further, in the mounting structure for cylindrical packing according to the embodiment, the positions of the front ends 325b of the protruding strips 325 are aligned with the front end 32b of the fitting cylindrical portion 32. Accordingly, when the cylindrical packing 40 starts to be fitted to the fitting cylindrical portion 32, the protruding strips 325 on the fitting cylindrical portion 32 start to be fitted to the engagement grooves 425 of the cylindrical packing 40 so immediately that the cylindrical packing 40 can be prevented from being displaced circumferentially. Therefore, even when the cylindrical packing 40 is fitted obliquely at the beginning of the fitting, distortion or displacement can be prevented from occurring in the cylindrical packing 40 so that the work for fitting the cylindrical packing 40 on the fitting cylindrical portion 32 can be further made easy.

In addition, in the mounting structure for cylindrical packing according to the embodiment, when the cylindrical packing 40 starts to be fitted to the fitting cylindrical portion 32, positioning between the protruding strips 325 and the engagement grooves 425 becomes easy so that mounting workability of the cylindrical packing 40 can be further improved.

Incidentally, the invention is not limited to the above-described embodiment but may be modified or improved suitably. In addition, the materials, the shapes, the dimensions, the number, the provision locations, etc. of the respective constituent elements in the above-described embodiment are not limited but may be set desirably as long as the invention can be achieved.

For example, the protruding strips 325 are provided in each of the end portion outer circumferential surfaces 322 and 323 in the opposite front and rear ends of the fitting cylindrical portion 32 in the above-described embodiment. However, the protruding strips 325 may be provided only in the end portion outer circumferential surface 322 on the front end side.

In addition, the end portion inner circumferential surfaces 422 and 423 in the cylindrical packing 40 do not affect the sealing performance. Therefore, the end portion inner circumferential surfaces 422 and 423 do not have to have dimensions small enough to be tightly attached to the end portion outer circumferential surfaces 322 and 323 as described in the above-described embodiment, but may have dimensions large enough to be loosely fitted to the end portion outer circumferential surfaces 322 and 323 so that mounting workability can be also improved.

Here, features of an embodiment of a mounting structure for cylindrical packing according to the invention which has been described above are summarized briefly in the following [1] to [3].

[1] A mounting structure for cylindrical packing for mounting a cylindrical packing (40) on a fitting cylindrical portion (32) of a first housing (30) to be inserted into an inner circumference of a cylindrical portion of a second housing such that the cylindrical packing (40) is fitted onto an outer circumferential surface of the fitting cylindrical portion (32) to thereby seal a gap between the cylindrical portion and the fitting cylindrical portion (32) watertightly,

wherein the outer circumferential surface of the fitting cylindrical portion (32) includes an intermediate portion outer circumferential surface (321) which has a fixed external shape, end portion outer circumferential surfaces (322 and 323) which are formed in opposite front and rear ends of the intermediate portion outer circumferential surface (321), respectively, and each of which is formed into a narrower external shape by removing a fixed thickness from the external shape of the intermediate portion outer circumferential surface (321), and a protruding strip (325) which extends axially on the end portion outer circumferential surface (322 and 323) provided on a front end side of the fitting cylindrical portion (32) and which is formed by the thickness removal for forming the end portion outer circumferential surfaces (322 and 323) such that a most protruding position of the protruding strip (325) from the end portion outer circumferential surface (322 and 323) falls within a range of the external shape of the intermediate portion outer circumferential surface (321),

wherein an inner circumferential surface of the cylindrical packing (40) includes an intermediate portion inner circumferential surface (421) which is tightly attached and fitted to the intermediate portion outer circumferential surface (321), and end portion inner circumferential surfaces (422 and 423) which are formed in opposite front and rear ends of the intermediate portion inner circumferential surface (421) to have a smaller diameter than the intermediate portion inner circumferential surface (421) to be thereby fitted to the end portion outer circumferential surfaces (322 and 323), respectively,

wherein an engagement groove (425) which allows the protruding strip (325) to be fitted therein is provided on the end portion inner circumferential surfaces (422 and 423) on the opposite ends so as to extend along front and rear directions, and

wherein a gap between the fitting cylindrical portion (32) and the cylindrical packing (40) is sealed watertightly due to tight attachment between the intermediate portion outer circumferential surface (321) and the intermediate portion inner circumferential surface (421).

[2] The mounting structure for cylindrical packing according to the above-described [1],

wherein a position of a front end of the protruding strip (325) is aligned with a position of a front end of the fitting cylindrical portion (32).

[3] The mounting structure for cylindrical packing according to the above-described [1] or [2],

wherein the external shape of each of the intermediate portion outer circumferential surface (321) and the end portion outer circumferential surfaces (322 and 323) is a shape of a rounded rectangle, and

wherein the protruding strip (325) is provided to protrude from a corner portion of the rectangle.

The mounting structure for cylindrical packing according to the invention is useful in the following point. That is, it is possible to provide a mounting structure for cylindrical packing in which a work for fitting a cylindrical packing on a fitting cylindrical portion can be made easy and sealing performance achieved by the cylindrical packing can be improved.

What is claimed is:

1. A mounting structure for cylindrical packing for mounting a cylindrical packing on a fitting cylindrical portion of a first housing to be inserted into an inner circumference of a cylindrical portion of a second housing such that the cylindrical packing is fitted onto an outer circumferential surface of the fitting cylindrical portion to thereby seal a gap between the cylindrical portion and the fitting cylindrical portion watertightly,
wherein the outer circumferential surface of the fitting cylindrical portion comprises:
an intermediate portion outer circumferential surface which has a fixed external shape,
end portion outer circumferential surfaces which are formed in opposite front and rear ends of the intermediate portion outer circumferential surface, respectively, and each of which is formed into a narrower external shape by removing a fixed thickness from the external shape of the intermediate portion outer circumferential surface, and
a protruding strip which extends axially on the end portion outer circumferential surface provided on a front end side of the fitting cylindrical portion and which is formed by the thickness removal for forming the end portion outer circumferential surfaces such that a most protruding position of the protruding strip from the end portion outer circumferential surface falls within a range of the external shape of the intermediate portion outer circumferential surface,
wherein an inner circumferential surface of the cylindrical packing comprises:
an intermediate portion inner circumferential surface which is tightly attached and fitted to the intermediate portion outer circumferential surface, and
end portion inner circumferential surfaces which are formed in opposite front and rear ends of the intermediate portion inner circumferential surface to have a smaller diameter than the intermediate portion inner circumferential surface to be thereby fitted to the end portion outer circumferential surfaces, respectively,
wherein an engagement groove which allows the protruding strip to be fitted therein is provided on the end portion inner circumferential surfaces on the opposite ends so as to extend along front and rear directions, and
wherein a gap between the fitting cylindrical portion and the cylindrical packing is sealed watertightly due to tight attachment between the intermediate portion outer circumferential surface and the intermediate portion inner circumferential surface.

2. The mounting structure for cylindrical packing according to claim 1,
wherein a position of a front end of the protruding strip is aligned with a position of a front end of the fitting cylindrical portion.

3. The mounting structure for cylindrical packing according to claim 1,
wherein the external shape of each of the intermediate portion outer circumferential surface and the end portion outer circumferential surfaces is a shape of a rounded rectangle, and
wherein the protruding strip is provided to protrude from a corner portion of the rectangle.
